(19) United States
(12) Patent Application Publication
(10) Pub. No.: US 2020/0370310 A1
(43) Pub. Date: Nov. 26, 2020

(54) BUILDING PERIMETER SYSTEMS

(71) Applicant: USG Interiors, LLC, Chicago, IL (US)

(72) Inventors: Abraham M. Underkofler, Salem, WI (US); Peder J. Gulbrandsen, Aurora, IL (US)

(21) Appl. No.: 16/420,438

(22) Filed: May 23, 2019

(51) Int. Cl. E04F 19/04; E04B 9/30; E04F 19/06

(52) U.S. Cl. CPC E04F 19/0468; E04F 2019/0413; E04F 19/061; E04B 9/30

(57) ABSTRACT

An architectural perimeter pocket assembly having at least a top and an inner side for forming an open bottom pocket, the inner side including an upper section and a lower extension section separately formed from the upper section, the sections having mutual engageable coupling formations horizontally displaced from main portions of said sections that when engaged enable the upper section to support the lower extension section vertically and restrain the lower section from pendulum-type motion.

### BACKGROUND OF THE INVENTION

The invention relates to improvements in building perimeter systems for ceiling and wall intersections that provide a pocket above the ceiling plane.

### PRIOR ART

Various systems have been proposed for constructing a so-called “pocket” situated above the perimeter of a ceiling adjacent a wall, typically an exterior wall. These pockets have been entirely fabricated on-site, out of framing materials and drywall, or have been constructed of prefabricated units or assembled panels of sheet metal or extruded aluminum. Premanufactured aluminum extrusions of the prior art have, for example, three integral sides.

A perimeter pocket can house one or two roll-up shades, curtain rods or channels, retracted blinds, lighting strips and/or HVAC grills, for example.

The requisite dimensions of a perimeter pocket vary depending on building design and interior designers specifications. A common design variable in current construction is the “depth” of a pocket, i.e. the vertical rise of the pocket above the plane of the ceiling proper. Accordingly, there is a need for a perimeter pocket system that can readily and conveniently provide different pocket depths depending on the specific application of the building at which the system is installed.

### SUMMARY OF THE INVENTION

The invention provides a building perimeter system with a main or base channel shaped pocket that couples with a selected one of different trim extensions. The selected extension corresponds to a desired rise of the pocket above the ceiling plane. The extension and main pocket channel have mating parts that facilitate their quick assembly into a horizontally locked joint that advantageously resists pendulum motion of the extension on the main channel.

The extension can be provided with an integral flange at a lower edge to support an acoustical ceiling tile or a sheet of drywall. In a preferred embodiment, the extension includes a flange on its concealed or outer side for attaching a stabilizing brace without piercing or otherwise affecting the aesthetics of the exposed side of the extension.

### BRIEF DESCRIPTION OF THE DRAWINGS

FIG. 1 is an end view of a perimeter pocket assembly of the invention; and

FIG. 2 is an enlarged view of a coupling area of the perimeter pocket assembly.

### DESCRIPTION OF THE PREFERRED EMBODIMENT

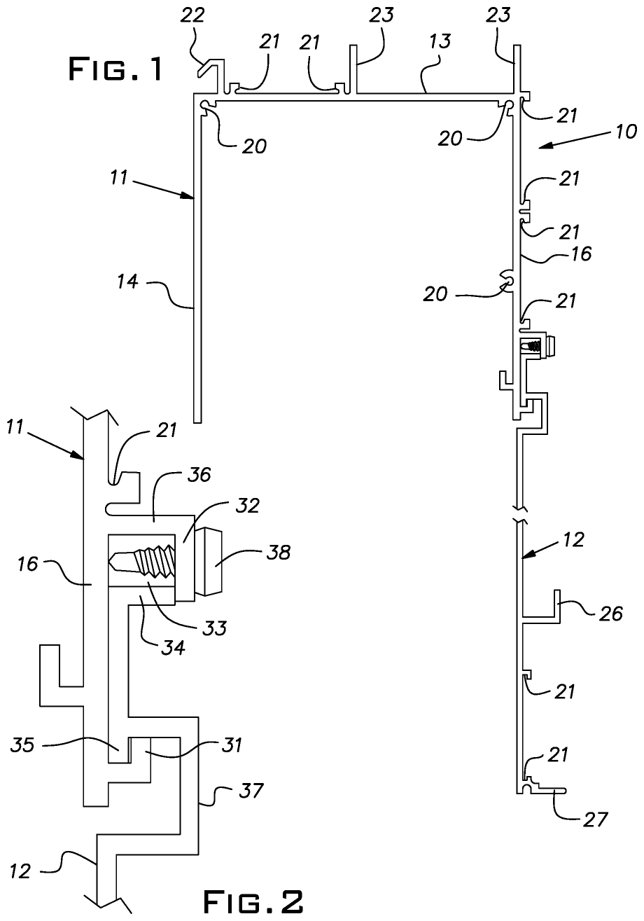

FIG. 1 illustrates an end or cross-sectional view of an example of the inventive pocket assembly 10. In the illustrated example, the assembly comprises a main part 11 in the form of an inverted rectangular U-shaped channel and an accessory part 12 in the form of a depending generally planar extension. The channel 11 and extension 12 can be provided in suitable lengths, such as 10 foot, and can preferably each be formed as an integral one-piece extrusion of architectural grade aluminum.

By way of example, but not limitation, the main part of channel 11 can be nominally 5 inches wide measured across a top 13 and 5 inches deep measured along vertical legs or sides 14, 16.

The illustrated channel 11 and extension 12 are preferably extruded of architectural grade aluminum. It will be understood that planar formations on the top and sidewalls 13, 14 and 16 of the channel and the extension 12 have walls of generally uniform thickness. These formations and other protuberances on the walls and extension typically extend continuously for the full length of the subject part. The length of each part 11, 12 will be understood to project perpendicularly to the plane of the FIGS. 1 and 2 drawings.

Extruded slots 20 on inside surfaces of the channel 11 can receive screws to secure end plates to ends of the channel. Sets of spaced, opposed slots 21 on exterior surfaces of the top 13 and inner leg or side 16 of the channel 11 and the extension 12 can receive framing clips such as disclosed in U.S. Pat. No. 9,476,194 or splice clips such as disclosed in U.S. Pat. No. 9,464,433.

A hook 22 can be used to suspend the assembly 10 on an exterior wall of a building. Two upstanding flanges 23 on the top 13 of the channel 11 can be used to receive and be attached to conventional sheet metal studs therebetween and thereby facilitate mounting of the assembly 10 in a building.

Ideally, the extension 12 is substantially planar and has a flange 26 of el-shaped cross-section on its one side. A brace (not shown) can be attached to either outside face of the flange 26, for example, with a self-drilling screw to supplement the stability of the extension 12. In the illustrated embodiment, a lower edge of the extension 12 includes a flange 27 for supporting an acoustical ceiling tile.

The channel 11 and extension 12 have mutually engageable formations or coupling elements that enable the extension to be easily and quickly manually assembled on and supported by the channel. These elements on the channel include an upstanding right angle hook 31 and a downwardly oriented right angle flange 32 forming with the main part of the leg or side 16 an open bottom slot 33 with a width preferably substantially greater, i.e. more than three times, the wall thickness of the extension 12. The coupling elements at an upper margin of the extension 12 include a horizontal flange 34 and a depending hook 35 spaced vertically below the flange. The vertical distance across a tip of the depending hook 35 and the upper surface of the flange 34 is less than the distance between the upstanding hook 31 and a horizontal part 36 of the flange 32. An offset 37 in the body of the extension 12 clears the upstanding channel hook 31 when the extension is mounted on the channel.

In normal installations, the channel 11 is mounted on a supporting wall or is otherwise fixed in space. Thereafter, the extension 12 is manually mounted on the inner leg or side 16 by tilting the extension 12 out of plumb so that the flange 34 can be positioned in the wide slot 33 while the upstanding hook 31 is avoided by the orientation of the extension 12. With the extension 12 sufficiently elevated relative to the channel 11 so that the depending hook 35 of the extension is higher than the upstanding hook 31 of the channel leg 16, the extension 12 is swung back into plumb and then lowered. The hooks 35 and 31 mutually inter-engage and maintain the flange 34 in the slot 33 and inter-engaged with the vertical part of the right angle flange 32 and the adjacent part of the leg 16.

Inter-engagement of the hooks 31, 34 with each other and the extension flange 34 with the surfaces forming the slot 33, as depicted in FIGS. 1 and 2, allows the channel 11 to vertically support the extension 12 and resist pendulum or swinging movement of the lower portion of the extension about the joint or coupling formed between these elements. The vertical spacing of the channel and extension coupling elements, being substantially greater than their wall thickness or at least 1/15 the height of the extension as shown is beneficial in obtaining a rigid assembly.

The extension 12 and channel 11 can be releasably locked together with one or several longitudinally spaced self-drilling screws 38, (one is shown in the figures), driven through the vertical part of the channel flange 32 above the upper flange 34 on the extension 12. Removal of the screw(s) 38 allows the extension 12 to be separated from the channel 11 by reversing the assembly steps. When assembled, the vertical planes of the channel leg 16 and the extension 12 are substantially coincident.

While the channel 11 is illustrated with a rectangular U-shaped configuration, other shapes are contemplated. For example, the channel 11 can have a right angle configuration comprising only an upper side or top and a depending leg corresponding to the leg 16.

The extension 12 can be produced in various heights, for example, in 4, 6 and 8 inches. This enables an architect or interior designer to select an extension that, combined with the channel, forms a desired pocket height.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. An architectural perimeter pocket assembly having at least a top and an inner side that form an open bottom pocket, the inner side including an upper section and a lower extension section separately formed from the upper section and extending along the upper section, each of the upper section and the lower extension section contributing to a vertical height of the inner side, the upper section comprising a coupling formation and the lower extension section comprising a coupling formation, the coupling formations being arranged to be mutually engaged when the lower section is lowered relative to the upper section, the coupling formation of the upper section being adjacent a lower edge of the upper section and the coupling formation of the lower section being adjacent an upper edge of the lower section, the coupling formations being horizontally displaced from main portions of said sections that enable the upper section to support the lower extension section vertically and restrain the lower extension section from pendulum movement.

2. The architectural perimeter pocket assembly as set forth in claim 1, wherein the upper section and lower extension section formations include mutual engagement surface areas of both sections that include two engagement zones, surfaces of the upper section and lower extension section being in mutual contact at each of the two engagement zones, the two engagement zones being spaced apart by a distance at least equal to 1/15 of a vertical length of the lower extension section wherein said formation engagement surfaces are engaged by lowering the lower extension section from an elevated position relative to the upper section to an installed position.

3. The architectural perimeter pocket assembly as set forth in claim 2, wherein the upper section formations include a vertically upstanding hook and the lower extension section formations include a vertically depending hook adapted to inter-engage with the upstanding hook.

4. The architectural perimeter pocket assembly as set forth in claim 3, wherein the upper section formations form an open bottom slot of a width greater than a wall thickness of the upper section.

5. The architectural perimeter pocket assembly as set forth in claim 4, wherein a vertical extent of the slot is greater than a height of the hooks.

6. The architectural perimeter pocket assembly as set forth in claim 5, wherein the lower extension section is locked in position relative to the upper section by a screw penetrating the upper section.

7. The architectural perimeter pocket assembly as set forth in claim 6, wherein said screw penetrates a part of the upper section projecting outwardly from a vertical plane of an outside face of a leg of the upper section.

8. The architectural perimeter pocket assembly as set forth in claim 7, wherein the lower extension section includes a flange projecting outwardly from a vertical plane along which the lower extension section lies, the flange being adapted to be secured to a stabilizing brace.

9. An architectural perimeter pocket assembly including a channel having a top and a depending leg and a generally planar extension generally coextensive in length with the depending leg, a lower end of the depending leg including a plurality of coupling elements, each of the plurality of depending leg coupling elements being below the top, an upper edge of the extension including coupling elements being engageable with the coupling elements of the depending leg upon vertically downward movement of the extension relative to the depending leg, the coupling elements of the depending leg and the coupling elements of the extension when joined being constructed and arranged to resist pendulum movement of the extension relative to the channel.

10. The architectural perimeter pocket assembly as set forth in claim 9, wherein said channel and said extension are made of extruded aluminum.

11. The architectural perimeter pocket assembly as set forth in claim 10, wherein said couplings are integrally formed on respective parts of said channel and said extension.

12. The architectural perimeter pocket assembly as set forth in claim 9, wherein said channel and said extension each have opposed formations for receiving splice elements therein.
